(19) United States
(12) Patent Application Publication
(10) Pub. No.: US 2004/0117252 A1
(43) Pub. Date: Jun. 17, 2004

(54) Method for linking different target groups and a suitable system for carrying out this method

(76) Inventor: Frank Knischewski, Rheden (DE)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/415,447

(22) PCT Filed: Oct. 30, 2001
(86) PCT No.: PCT/EP01/12544

(30) Foreign Application Priority Data
Oct. 30, 2000 (DE) 100-53-738.3

(51) Int. Cl. G06F 17/60

(52) U.S. Cl. 705/14

(57) ABSTRACT

The invention concerns a method for linking different target groups. By standardizing information, the invention enables the target groups to be linked in a simpler and more targeted manner.

The present invention concerns a method of linking different target groups and a suitable system for carrying out this method.

Due to the increasing volume and density of information, it is becoming increasingly difficult to locate and assign suitable and necessary information for users and different target groups. This is apparent especially with the use of the Internet, which, to be sure, allows a certain amount of assignment of information by the available search engines, but the increasing hit frequency leads to the situation that working through the located hits is time-consuming, and there is often a certain amount of uncertainty with respect to prioritization by the search engines and uncertainty about the optimum utilization of the information.

Therefore, the object of the invention is to develop a method for linking different target groups and especially to develop a suitable system for carrying out this method, with which assignment of information is allowed in a simple way and with a certain amount of certainty for the user.

This goal is achieved with respect to the method by the features of Claim 1 and with respect to the system with the features of Claim 18.

In accordance with the invention, the method for linking different target groups, which comprise at least one product provider system and one business service provider system, has the following steps: a switching unit, which links the product provider system with the business service provider system, is made available; information, which is supplied by the product provider system and/or the business service provider system to the switching unit, is standardized; and the standardized information is displayed.

This measure makes it possible, by suitable linkage, for different target groups, which consist of at least one product provider system and one business service provider system, to exchange information, which, due to the standardization, represents reliability for both target groups, and, in addition, a common basis of communication is created. In this connection, the standardization can take on the job of ensuring that, in particular target groups, those things are offered which are of interest to them, and, in particular, personalization for the particular target groups can be realized by this standardization. With the method of the invention and with the system of the invention, this personalization allows adaptation to the interests of the target groups, which possibly can be adapted by different access rights. Accordingly, exactly the information that corresponds to the interests and rights of the target groups is displayed to the target groups by means of the standardized information. In this connection, the further possibility is provided that the particular target groups remove partial areas from the standardized information, in order to ensure that no redundant information is displayed, which, for example, might confuse the particular target groups. Furthermore, despite selection of information from the standardized information, it is guaranteed that optimum linkage of different target groups is possible.

Other advantageous refinements of the present invention are objects of the secondary claims.

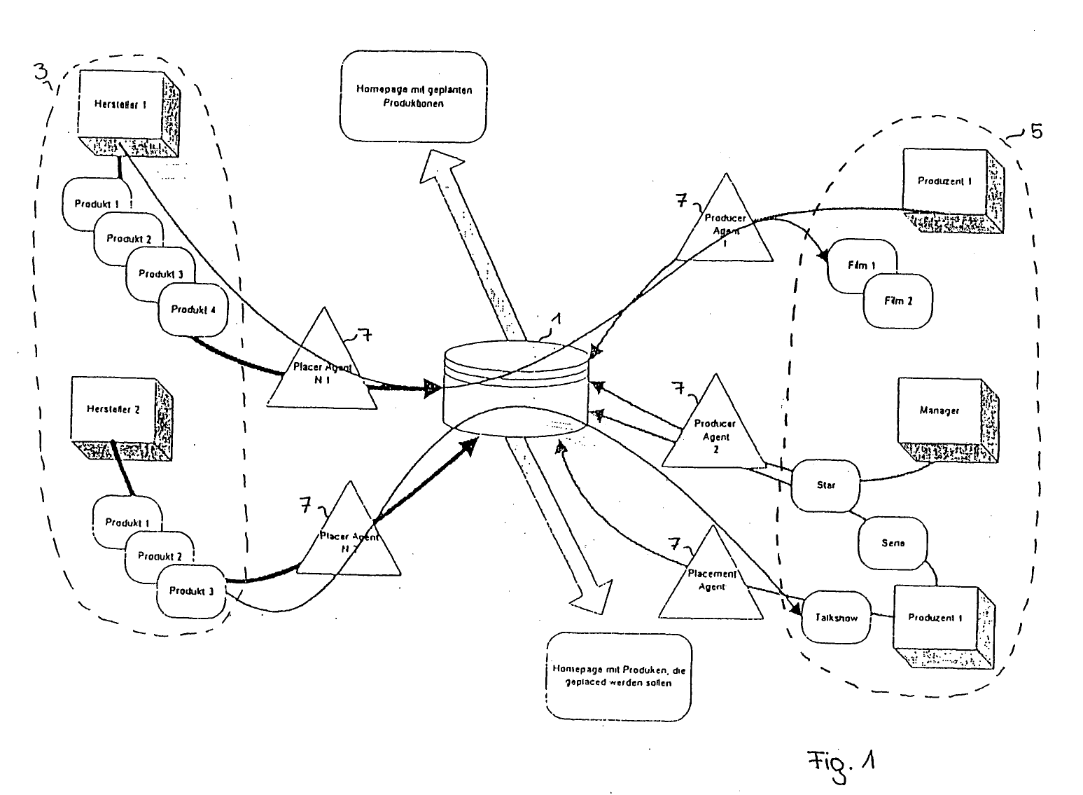

If, for example, the standardization of information is realized by first agents [these are apparently represented by the triangles in FIG. 1—Tr. Ed.], which are positioned in the information flow between the product provider system and/or the business service provider system and the switching unit, then it is no longer necessary for the target groups to go through the time-consuming process of working through the information, which, for example, is compiled incompletely or in a disorderly way by the product provider system. Another advantage of the first agents is that, due to the frequent processing of information, a certain routine can become established, and thus more effective processing or standardization of information is realized.

If, for example, the product provider system consists of at least two providers, each of which offers at least one product, then a selection of products is made available to the business service provider system, which normally, due to different identification codes of the product provider systems, would show no linkage to the business service provider system.

A further advantage is gained, if the business service provider system comprises at least two service providers that offer services in the sector of the television and film industry. In this way, products of a product provider system are made available to an outside target group, which enhances the productivity and operation of the business service provider system.

If the product is adapted to the business service provider system, there is a greater probability for the product provider system that the business service provider system will make use of the product provider system.

If, for example, the information is standardized by the formats prescribed by the switching unit, it is possible, for example, to revert to already existing switching units.

If, for example, the standardized information is displayed, preferably by the switching unit, via a homepage of the Internet or a general communication network related to the target groups, then the method in accordance with the application or the system in accordance with the application is accessible for almost any product provider system or business service provider system and thus requires no individual adaptation of different communication systems. If, for example, the information is supplied to the switching unit via several first agents, then, on the basis of the different information, the editing can be optimally accomplished by different first agents.

If the changes in the information that was prepared by the product provider system and/or the business service provider system is displayed in close temporal proximity, preferably in real time, by the switching unit, then there is the possibility for the target groups to be certain about the correctness of the information.

If the standardization of information is additionally carried out partly via an input function, which allows a selection and/or an exclusion of the products or services that constitute the information, it is possible to achieve a situation in which the user is not forced to enumerate all products or services for which he desires a link or would like to receive a display of hits, but rather, by naming a product or a specific service provider or product provider, he can stipulate the products to which he does not want a link. This measure increases the input possibility for the user by simple means, such that the user is assured of having displayed to him all products or services that do not fall within the exclusion but are included in the overall concept.

Furthermore, if the means of input encounters the selection and/or exclusion of products in tabular form, the user can readily match whether the inputs for the selection and/or the exclusion of products or services are in agreement. However, matching of this kind may also proceed separately in the background of the system, if specific defaults are present, which do not allow the naming of information in either the selection field or the exclusion field.

In the case of several linking operations, in order to not always have to re-input the selection or exclusion field with contents, i.e., products or services, provision can be made to name a series of products and services in the selection or exclusion field, which, however, are activated only via a tag element for the given linking step or for placement in the system. In addition, it is advantageous to subdivide the registration for use into limited-time use and permanent use. In this way, the management of the users can be systematically controlled; in particular, guest use can also be allowed, which makes it possible only to become acquainted with the system and does not unnecessarily burden the management of the total system.

In this regard, it was found to be advantageous in the case of limited-time use, so-called guest use, if the user transmits his e-mail address for verification purposes, on the basis of which the credibility and return potential of the user can be checked.

The operating principle of the linking of target groups will now be discussed in detail with reference to the drawings.

FIG. 1 is an overview of the manner of operation of the application method and of the application system.

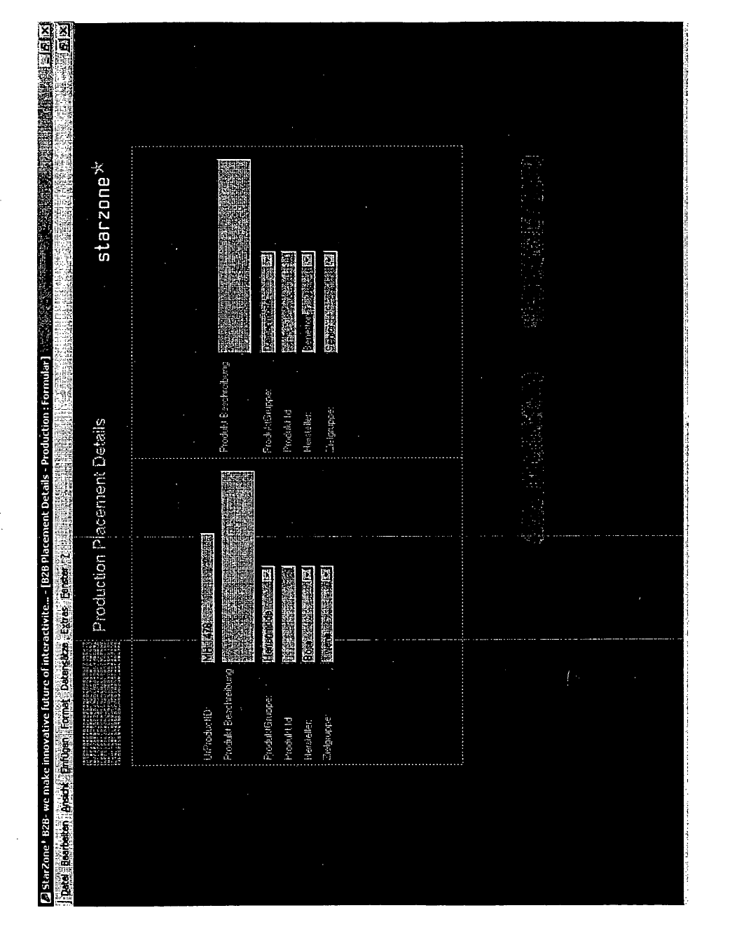

FIG. 2 shows a means of input used in the method and system in accordance with the invention.

In FIG. 1, a switching unit is shown, which links the product provider system 3 with the business service provider system 5 and displays the supplied information. The individual linking possibilities are indicated, for example, with different arrows. In addition, first agents 7 are provided, each of which is positioned between the product provider system 3 and the business services provider system 5. As is indicated in the drawing, the individual first agents may be different agents, which can carry out partially specialized standardization.

The drawing also shows (see heavy arrows) that the information provided in the switching unit 1 can be displayed, for example, by means of a homepage; in this embodiment, there is the possibility of providing one homepage for planned productions and one homepage with products that are to be placed. The drawing further shows that, for example, several products of both the business services provider system and the product provider system can be supplied to the switching unit via the agents, and in this regard, different business service providers are able to make the information available to the switching unit via one agent.

With respect to the mode of operation of the method of the application and the system of the application, it should be noted that, for example, by using graduated access rights, not every user may see all contents of the information; specifically, every user does not need all of the contents.

As a result, the user or an outside third party receives on his display only that information which is of interest to him, but of that information which is of interest to him, he gets to see everything. The website or homepage brought up for display is then personalized, if it is adapted to the interests of the user and takes his access rights into account. Each user receives his own personal website. In this way, the situation with respect to the interests of the user is taken into account in such a way that the user sees only the information that corresponds exactly to his interests when he is using the method and system in accordance with the application. In the usual situation, menus and buttons can be offered which lead to the offers that the user needs and that he would like to see and may see. Another advantageous embodiment is that unimportant information is extracted, which is useful for the most continuous possible collection of relevant information.

Access rights are determined from the position of the user relative to the use. The status is stored as a person-specific or user-specific and/or service-specific profile. That is, each time the user calls up the homepage again, the display will conform to his profile. Another advantageous modification is automatic and/or dynamic navigation, which is available through the setting up of a sitemap at the instant the homepage is called up. Furthermore, the current structure is displayed, and, in addition, the user is automatically informed of all the latest information.

The method and system in accordance with the application thus open the way to interactive and individual information presentation, and the user spends his time using the information rather than searching for it.

Furthermore, the method and system of the invention thus make automatic, so-called placement possible, i.e., the bringing together of products and services, with which, in addition, commission calculation and accounting are possible. Systematic direct management of all items that were placed in a production allows unique identification. Likewise, an interface to anonymous data outputs is formed by the presence of an updating device for the placer or placement agent, and product data maintenance and logistic data maintenance can be carried out in this way.

FIG. 2 shows a means of input in the form of an interactive input field of the placement. In particular, there are two fields, a selection field 10 and an exclusion field 12, which contain several interactive input boxes, into which the given products or services can be input as information. The selection field 10, which is labeled “Should” also contains an identification ID of the particular link in order to allow assignment in the reprocessing in the total concept. Furthermore, additional input boxes with specific information are given, by which standardization of the information is possible. The exclusion field 12, which is labeled “May Not” preferably contains input boxes corresponding to the selection field 10, so that the exclusion possibility is clearly given. In this connection, it is also conceivable that, depending on the selection of information in the selection field, the corresponding exclusion fields can be automatically preset by the total system or can be displayed to the user as exclusion possibilities. After input in the individual fields, i.e., the selection field and/or exclusion field, the operation is sent to the overall system through the input box “Place it” and further processed accordingly.

It is also conceivable for the graduated access rights to be used to subdivide the area of use into a public area and a “registered visit”. It is also possible to couple the duration of the linking possibilities to the access rights or to set the duration of the linking possibilities for use of the total system periodically, preferably in a variable manner. Basically, it is possible for the user to create person-specific areas, to which only he has access and on the basis of which, from time to time, he can obtain information about the specific status of his links. The standardized information can be displayed by the switching unit in a variety of ways, including conventional ways.

1. Method for linking different target groups, which comprise at least one product provider system and one business service provider system, with the following steps:
(a) making available a switching unit, which links the product provider system with the business service provider system,
(b) standardization of information, which is supplied by the product provider system and/or the business service provider system to the switching unit, and
(c) displaying the standardized information.

2. Method in accordance with claim 1, in which information is standardized by first agents, which are positioned between the product provider system and/or the business service provider system and the switching unit.

3. Method in accordance with claim 1 or claim 2, in which the product provider system consists of at least two product providers, each of which offers at least one product.

4. Method in accordance with any of claims 1 to 3, in which the business service provider system consists of at least two business service providers, which offer services in the sector of the television and film industry.

5. Method in accordance with any of claims 1 to 4, in which the product is adapted for the business service provider of the business service provider system.

6. Method in accordance with any of claims 1 to 5, in which the standardization occurs via formats prescribed by the switching unit.

7. Method in accordance with any of claims 1 to 6, in which the standardized information is displayed via a homepage of the Internet or via one's own communication network.

8. Method in accordance with any of claims 1 to 7, in which a business service provider and/or product provider supplies information to the switching unit via several first agents.

9. Method in accordance with any of claims 1 to 8, in which the changes in the information prepared by the product provider system and/or the business service provider system are displayed in close temporal proximity, preferably in real time.

10. Method in accordance with any of claims 1 to 9, in which the search criteria for the linking by the switching unit are based on semantic search technologies.

11. Method in accordance with any of claims 1 to 10, in which the display of the information is specified in person-specific or user-specific and/or service-specific form.

12. Method in accordance with any of claims 1 to 11, in which the displaying of the information can be determined by automatic and/or dynamic navigation.

13. Method in accordance with any of claims 1 to 12, in which the information is standardized via a means of input, which makes it possible to select and/or exclude information, preferably products and services.

14. Method in accordance with claim 13, in which the means of input encounters the selection and/or exclusion of information in tabular form.

15. Method in accordance with claim 13 or 14, in which the selection and/or the exclusion occurs by activation of a tag element.

16. Method in accordance with any of claims 1 to 15, in which registration for use of the link is provided, which allows limited-time use or permanent use.

17. Method in accordance with claim 16, in which, in the case of limited-time use, the user transmits his e-mail address for verification and/or receives only limited possibilities in the linking of target groups.

18. System for linking different target groups, which comprise at least one product provider system and one business service provider system, which has:
(a) a switching unit, which links the product provider system with the business service provider system,
(b) a standardization unit for information, which is supplied by the product provider system and/or the business service provider system to the switching unit, and
(c) a display unit for displaying the standardized information.

19. System in accordance with claim 18, in which first agents are provided for preparation for the information standardization unit.

20. System in accordance with claim 18 or 19, in which the product provider system consists of at least two product providers, each of which offers at least one product.

21. System in accordance with any of claims 18 to 20, in which the business service provider system consists of at least two business service providers, which offer services in the sector of the television and film industry.

22. System in accordance with any of claims 18 and 21 [sic? “18 to 21”?—Tr. Ed.], in which the product is adapted for the business service provider of the business service provider system.

23. System in accordance with any of claims 18 and 22 [sic? “18 to 22”?—Tr. Ed.), in which the standardization occurs via formats prescribed by the switching unit.

24. System in accordance with any of claims 18 to 23, in which the standardized information is displayed via a homepage of the Internet or via one's own communication network.

25. System in accordance with any of claims 18 to 24, in which a business service provider and/or product provider supplies information to the switching unit via several first agents.

26. System in accordance with any of claims 18 to 25, in which the changes in the information prepared by the product provider system and/or the business service provider system are displayed in close temporal proximity, preferably in real time.

27. System in accordance with any of claims 18 to 26, in which the search criteria for the linking by the switching unit are based on semantic search technologies.

28. System in accordance with any of claims 18 to 27, in which the display of the information is specified in person-specific or user-specific and/or service-specific form.

29. System in accordance with any of claims 18 to 28, in which the displaying of the information can be determined by automatic and/or dynamic navigation.

30. System in accordance with any of claims 18 to 29, in which the information is standardized via a means of input, which makes it possible to select and/or exclude products or services that constitute the information.

31. System in accordance with claim 30, in which the means of input encounters the selection and/or exclusion of information in tabular form.

32. System in accordance with claim 18 or 29 [sic? “28 or 29” may have been intended (see claim 15)—Tr. Ed.], in which the selection and/or the exclusion occurs by activation of a tag element.

33. System in accordance with any of claims 18 to 32, in which a means of registration for using the link is provided, which allows limited-time use or permanent use.

34. System in accordance with claim 33, in which, in the case of limited-time use, the user transmits his e-mail address for verification and/or receives only limited possibilities in the linking of target groups.
